(19) United States
(12) Patent Application Publication
(10) Pub. No.: US 2015/0309693 A1
(43) Pub. Date: Oct. 29, 2015

(54) CURSOR ASSISTANT WINDOW

(71) Applicant: Acer Incorporated, New Taipei City (TW)

(72) Inventors: Chien-Hung LI, New Taipei City (TW); Ling-Fan TSAO, New Taipei City (TW); Tung-Chuan WU, New Taipei City (TW); Yu-Hsuan SHEN, New Taipei City (TW); Yueh-Yarng TSAI, New Taipei City (TW)

(21) Appl. No.: 14/600,065

(22) Filed: Jan. 20, 2015

(30) Foreign Application Priority Data
Apr. 24, 2014 (TW) 103114795

(51) Int. Cl. G06F 3/0481; G09G 5/14; G06F 3/041; G06F 3/0484; G06F 3/0488

(52) U.S. Cl. CPC G06F 3/04812; G06F 3/0481; G06F 3/04845; G06F 3/04883; G06F 3/0412; G09G 5/14; G09G 2340/045; G09G 2354/00

(57) ABSTRACT

A touch device is configured to display a touch activated cursor on a touch screen. The touch device is also configured to detect an assistant window triggering movement of the touch activated cursor on the touch screen. In response to detection of the assistant window triggering movement, the touch device is configured to display an assistant window on the touch screen. The assistant window magnifies a portion of the touch activated cursor as well as magnifies a display area of the touch screen adjacent to an end of the touch activated cursor.

### RELATED APPLICATION DATA

This application claims priority under 35 U.S.C. 119 to Taiwan patent application, TW 103114795, filed on Apr. 24, 2014, the disclosure of which is incorporated herein by reference.

### TECHNICAL FIELD

### Background

Touch sensors or touch panels have become a popular type of user interface and are used in many types of electronic devices, such as mobile phones, personal digital assistants (PDAs), navigation devices, video games, computers (e.g., tablets), etc., collectively referred to herein as touch devices. Touch devices recognize a touch input of a user and obtain the location of the touch to effect a selected operation.

A touch panel may be positioned in front of a display screen such as a liquid crystal display (LCD), or may be integrated with a display screen. Such configurations, referred to as touch screens, allow the user to intuitively connect a pressure point of the touch panel with a corresponding point on the display screen, thereby creating an active connection with the screen. In general, a finger or stylus is used to interact with the touch screen to, for example, select various displayed objects (e.g., icons, menus, etc.). In certain cases, a displayed object may be small, thereby making it difficult for users to quickly or accurately select the displayed object.

### SUMMARY

In accordance with certain embodiments presented herein, a touch device is configured to display a touch activated cursor that enhances a user's ability to select objects on the touch screen. The touch device is also configured to detect an assistant window triggering movement of the touch activated cursor on the touch screen. In response to detection of the assistant window triggering movement, the touch device is configured to display an assistant window on the touch screen. The assistant window magnifies a portion of the touch activated cursor as well as magnifies a display area of the touch screen adjacent to an end of the touch activated cursor.

### BRIEF DESCRIPTION OF THE DRAWINGS

Embodiments are described herein in conjunction with the accompanying drawings, in which:

FIG. 1 is a schematic diagram of a touch device configured to display a touch activated cursor and assistant window in accordance with embodiments of the present invention;

FIGS. 2A and 2B are schematic diagrams illustrating assistant windows in accordance with embodiments of the present invention;

FIG. 3 is a schematic diagram illustrating a window assistant triggering movement in accordance with embodiments of the present invention;

FIG. 4 is a schematic diagram illustrating a window assistant closing action in accordance with embodiments of the present invention;

FIGS. 5A-5C are a series of schematic diagrams illustrating another window assistant triggering movement in accordance with embodiments of the present invention;

FIGS. 6A and 6B are a series of schematic diagrams illustrating another window assistant triggering movement in accordance with embodiments of the present invention;

FIG. 7 is a block diagram of a touch device configured to display a touch activated cursor and an assistant window in accordance with embodiments of the present invention;

FIG. 8 is a detailed flowchart of a method in accordance with embodiments of the present invention; and

FIG. 9 is a high-level flowchart of a method in accordance with embodiments of the present invention.

### DESCRIPTION OF EXAMPLE EMBODIMENTS

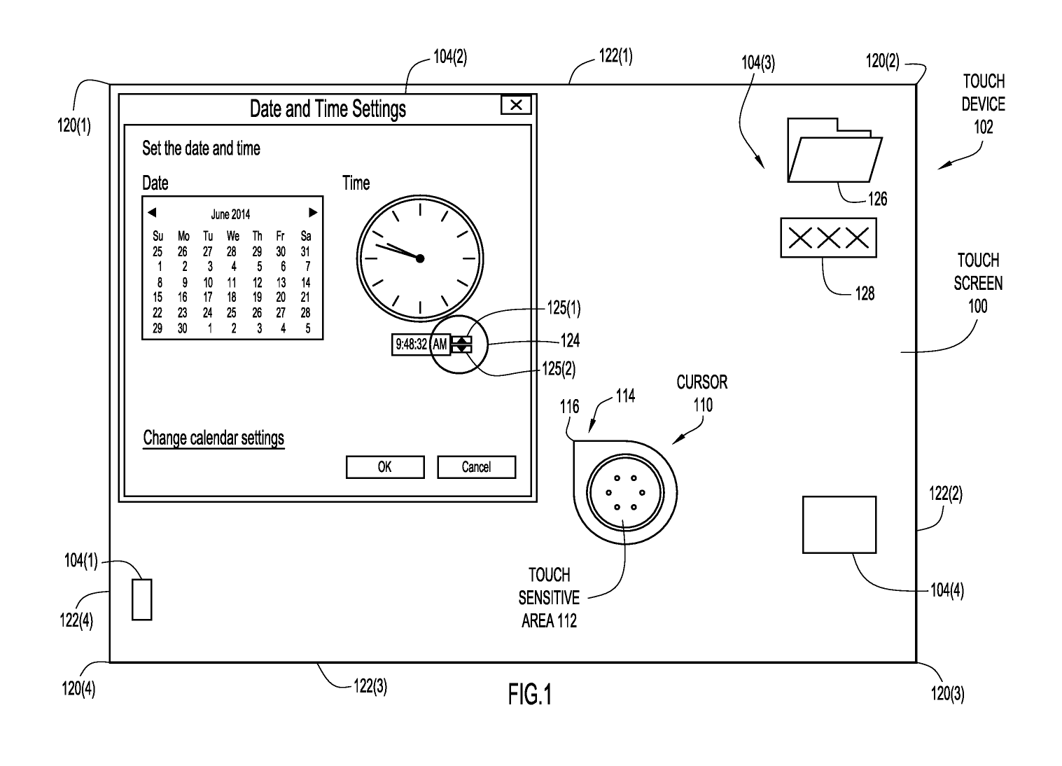

FIG. 1 is a schematic diagram of a touch screen 100 of a touch device 102 configured to display a touch activated cursor 110 and an assistant window (not shown in FIG. 1). The touch device 102 may be, for example, a tablet computing device, mobile phone, personal digital assistant (PDA), desktop computer, navigation device, laptop computer, a game console, or any other device that includes a touch screen.

Touch screen 100 comprises a touch sensor/panel that is positioned in front of, or integrated with, a display screen. Touch screen 100 is configured to recognize touch inputs of a user and determine the location of the touch input. The touch screen 100 connects a pressure point of the touch panel with a corresponding point on the display screen, thereby providing the user with an intuitive connection with the screen. The touch input may be, for example, physical contact via a finger, a stylus, etc. It is to be appreciated that the touch device 102 may also include other types of user interfaces, such as, for example, a keyboard, a mouse, a trackpad, etc. These alternative user interfaces have, for ease of illustration, been omitted from FIG. 1.

As shown, the touch screen 100 has corners 120(1), 120(2), 120(3), and 120(4). A first edge 122(1) of the touch screen 100 extends between the first corner 120(1) and the second corner 120(2), while a second edge 122(2) of the touch screen 100 extends between the second corner 120(2) and the third corner 120(3). A third edge 122(3) of the touch screen 100 extends between the third corner 120(3) and the fourth corner 120(4), while a fourth edge 122(4) of the touch screen 100 extends between the fourth corner 120(4) and the first corner 120(1). The touch screen 100 may have a generally square shape where all edges 122(1)-122(4) are the same length or a generally rectangular shape where two parallel edges (e.g., edges 122(1) and 122(3) or edges 122(2) and 122(4)) are longer than the other two edges.

The touch screen 100 is configured to display a plurality of user interface (UI) elements 104(1)-104(4), sometimes referred to herein as displayed objects 104(1)-104(4). The displayed objects 104(1)-104(4) may comprise, for example, icons, menus, tools/toolbars, panels, documents, etc. In certain embodiments, the displayed objects 104(1)-104(4) may be small in size, thereby making it difficult for users to quickly or accurately select the displayed objects. As such, the touch device 102 is configured to display a touch activated cursor (touch cursor) 110 on the touch screen 100 that enhances a user's ability to select displayed objects 104(1)-104(4). The touch cursor 110 may be initially displayed on the touch screen 100 by, for example, accessing a tool menu, by default, etc.

The touch cursor 110 comprises a touch sensitive area 112 and a pointer 114. The pointer 114 has a general triangular or arrowhead shape extending from the touch sensitive area 112 and terminates in a fine tip (point) 116. Using the touch cursor 110, a user can select, drag, tap/click, etc. on objects 104(1)-104(4) that may be difficult to select with a fingertip. More specifically, a user can place a fingertip on the touch sensitive area 112 and drag the touch cursor 110 to different points on the touch screen 100. In general, the touch cursor 110 can be dragged in any direction until the touch sensitive area 112 reaches an edge of the touch screen 100.

As shown in FIG. 1, the touch cursor 110 may have a default orientation where the tip 116 of pointer 114 points towards the first corner 120(1) of the touch screen. In certain examples, the orientation of the touch cursor 110 may automatically rotate depending, for example, one the location or movement of the cursor (e.g., the tip 116 of the cursor 110 may rotate so as to point in different directions).

Through touches at the touch sensitive area 112, the touch cursor 110 also enables a user to perform all standard touch screen commands including tap, double-tap, drag, and drag-select, etc. For example, to select an item on the screen, such as displayed object 104(1), the touch sensitive area 112 is used to position the tip 116 of pointer 114 over the object 104(1). The user may then tap or double-tap the touch sensitive area 112, causing the object 104(1) (i.e., the item positioned underneath the tip 116) to be selected.

Additionally, to drag an item, such as displayed object 104(1), across the touch screen 100, the touch sensitive area 112 is used to position tip 116 of pointer 114 over the displayed object 104(1). The user may then press briefly on the touch sensitive area 112 to activate a drag mode during which the displayed object 104(1) can be dragged to a new location. When the displayed object 104(1) is at a new position, the user may then again briefly press the touch sensitive area 112 to deactivate the drag mode and release control over the displayed object 104(1) (i.e., cause the displayed object to remain at the new location).

As noted above, the cursor 110 enables a user to perform all standard touch screen commands (e.g., activation of menus/displays, text editing, etc.) through one or more touches at the touch sensitive area 112. In general, since the tip 116 of pointer 114 has a size/shape that is smaller than a typical user's fingertip, the pointer 116 enables greater granularity and selectability in comparison to a fingertip touch. That is, the touch cursor 110 provides a user with precise pointing control on the touch screen 100 in situations where it may be difficult to do so using only a fingertip. The fine tip 116 allows a user to work with small screen elements which may be particularly helpful when using operating system setting and configuration windows with small buttons, boxes or other small items.

However, although the tip 116 of pointer provides more granularity than a user's fingertip, certain displayed objects may include features that are still difficult to select. For example, FIG. 1 illustrates a displayed object 104(2) in the form of a calendar that includes a composite button 124 formed by a first scroll arrow 125(1) and a second scroll arrow 125(2) (i.e., the composite button 124 is comprised of opposing scroll arrows). FIG. 1 also illustrates a displayed object 104(3) in the form of a file folder 126 with an associated text field 128. Text characters may be entered into the text field 128 by a user and/or text contained therein may be selected and edited by a user.

For ease of illustration, the scroll arrows 125(1)/125(2) and text field 128 are shown at an enlarged scale relative to touch cursor 110. In practice, the scroll arrows 125(1)/125(2) and text field 128 may be substantially small and require delicate touches by a user to select, for example, the correct scroll arrow, the text field, or even a specific text character within the text field. As such, it may be easy for a user to miss the scroll arrows 125(1)/125(2) or the text field 128 or experience difficulty in selecting a specific text character or location within the text field.

A user may attempt to select part of a displayed object, such as text field 128 of displayed object 104(3), by dragging the touch cursor 110 from a distant screen location to the text field 128. In this scenario, if the user moves the cursor over and past the text field 128 (i.e., misses the object), the user will drag the cursor back to aim it again at the text field 128. If the user again misses the text field 128, the user will generally drag the touch cursor 110 back and forth again until the text field 128 is selected. A user may also attempt to select text field 128 by dragging the touch cursor 110 from a nearby screen location. By the design of certain operating systems, the move by the user will not be recognized unless the user drags the cursor a predetermined distance (e.g., more than 3 pixels). Thus, in such examples a user will always miss the text field 128 if the tip 116 of touch cursor 110 starts very close to the text field. As a result, the user will again generally drag the touch cursor 110 back and forth again until the text field 128 is selected.

Embodiments of the present invention are generally directed to techniques for improving a user's touch experience by providing users with greater ability to accurately and effortlessly select relatively small objects or portions of objects displayed on a touch screen. More specifically, embodiments are directed to the display of an “assistant window” to magnify a target area of the touch screen (i.e., the area/object that is the target of a user's move) and part of the cursor. As described further below, the techniques presented herein monitor the movement of the touch activated cursor on the touch screen and use a specific detected movement to trigger/activate the assistant window. Once activated, the assistant window 130 magnifies a portion of the touch activated cursor and a display area of the touch screen adjacent to an end of the touch activated cursor. Provided first below is a description of the design features of the assistant window, followed by a description of the how the assistant window is activated/triggered and subsequently deactivated/closed.

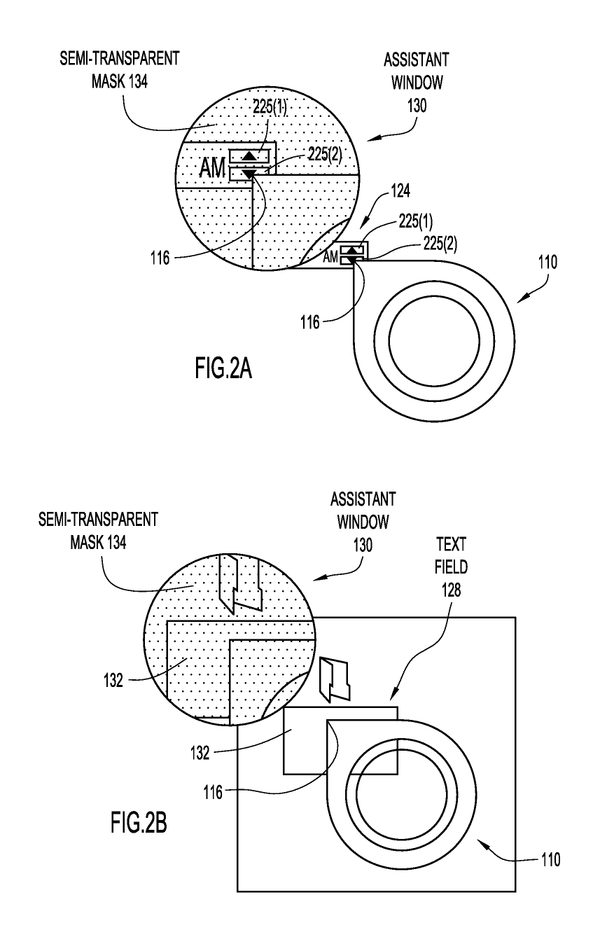

FIGS. 2A and 2B generally illustrate an assistant window 130 in accordance with embodiments of the present invention. As shown in FIGS. 2A and 2B, the assistant window 130 is a pop-up element that provides a magnified/enlarged view of a selected area of a touch screen. In the example of FIG. 2A, the assistant window 130 is used within a composite button 124 that includes the scroll arrows 125(1) and 125(2) (i.e., the target area of the touch screen is the composite button 124). As such, the assistant window 130 provides a magnified view of the composite button 124, including the scroll arrows 125(1) and 125(2). In the example of FIG. 2B, the assistant window 130 is used to magnify a section/area 132 of a text field 128 (i.e., section 132 is the target area).

As shown in FIGS. 2A and 2B, the assistant window 130 also provides a magnified view of at least a portion of the cursor 110, particularly tip 116. As such, the user may use the magnified views so as to properly locate the tip 116 at the correct part of the target area thereby facilitating the selection or “clicking” of the correct part of the target area.

In operation, when the assistant window 130 is activated, the assistant window displays a magnified view of an area within a predetermined distance from the tip 116, including a distance into touch cursor 110. It is to be appreciated that the magnified region may also change as the touch cursor 110 is moved by a user. In other words, the assistant window 130 is configured to move with the tip 116 of the touch cursor 110 so as to continually display and magnify the area of the touch screen within the predetermined distance of tip 116 (i.e., the magnified area displayed within assistant window 130 is not static, but rather may be constantly updated).

In order to make a user more comfortable viewing the assistant window 130, the assistant window may also be covered by a semi-transparent black mask 134. That is, the magnified area of the touch screen displayed within the assistant window 130 is covered by the semi-transparent mask 134. The semi-transparent mask 134 may have a transparency of approximately 90% to approximately 95%, though other levels of transparency may be used. In certain embodiments, the level of transparency of the semi-transparent mask 134 is adjustable by, for example, a user. It is also to be appreciated that the use of a semi-transparent mask 134 is illustrative and that the mask may be omitted from certain embodiments.

FIGS. 2A and 2B illustrate the assistant window 130 having a generally circular shape. It is to be appreciated that the circular shape of FIGS. 2A and 2B is illustrative and that the assistant window 130 may have other shapes in alternative embodiments (e.g., square, rectangle, oval, etc.)

The size of the assistant window 130 and the amount of magnification provided thereby may vary. In one embodiment the assistant window 130 has a default size and magnification. In certain embodiments, the size and/or the magnification of the assistant window 130, as well as the distance from the tip 116 that is to be magnified, is adjustable by a user. The adjustability of the size, magnification, etc. of the assistant window 130 may account for the preferences of different users. For example, a user with impaired vision may prefer a larger assistant window with greater magnification than a user with unimpaired vision. Therefore, certain embodiments provide a user with the ability to change the characteristics of the assistant window 130, including the size, shape, magnification, transparency, etc.

As noted above, an assistant window in accordance with embodiments of the present invention, such as assistant window 130 of FIGS. 2A and 2B, is configured to display a magnified view of a target area of a touch screen. The window assistant 130 is generally not present at the touch screen, but rather is activated and displayed on-demand in response to a particular movement of the touch activated cursor 110.

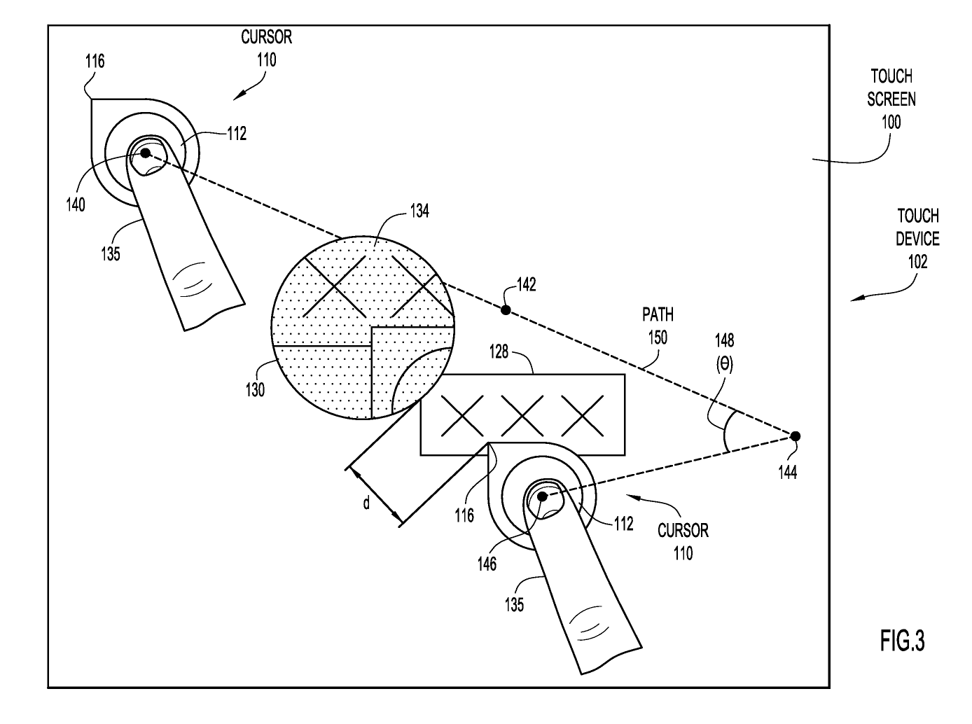

More specifically, FIG. 3 is a schematic diagram illustrating the detection of cursor movement in accordance with embodiments of the present invention that is configured to cause activation of an assistant window. The specific movement of a cursor that will cause activation of an assistant window is referred to herein as an “assistant window triggering movement” or simply “triggering movement” of a touch cursor. For ease of illustration, the example of FIG. 3 is described with reference to touch cursor 110 displayed at touch screen 100 of touch device 102, all described above with reference to FIG. 1, as well as with reference to the assistant window 130 of FIGS. 2A and 2B.

As shown, the user places a finger 135 at the touch sensitive area 112 and applies downward pressure (i.e., in the direction of touch screen 100) while the touch cursor 110 is located at a first location (point) 140. While continuing to apply press on the touch sensitive area 112, the user drags the touch cursor 110 along a path 150 defined by locations 140, 142, 144, and 146. The path 150 illustrates a representative movement of the touch cursor 110 when the user attempts to select the text field 128. As shown, the user moves the cursor 110 from location 140 to location 144, passing through location 142. At location 144, the user realizes that the cursor 110 has passed (i.e., missed) the text field 128 and thus moves the touch cursor 110 from location 144 to location 146 closer to text field 128.

The path 150 illustrates an example “switchback” movement of cursor 110. As used herein, a switchback movement of the touch cursor 110 refers to movement of the cursor along a path defining an angle 148 (angle θ) that is less than or equal to approximately forty-five (45) degrees (°). In accordance with embodiments presented herein, the angle 148 may be determined based on three sampling points (e.g., points 142, 144, and 146). In one example, the touch device 102 tracks/records data representing the movement of the touch cursor 110 along the touch screen 100. The touch device 102 may detect a direction change and record the location of the direction change (i.e., location 144). The touch device 102 may then select a prior sampling point (e.g., location 142) using the tracked movement data and then select a subsequent sampling point (e.g., location 146). The sampling point 144 coincides with the direction change, but the other two sampling points may be selected based on a number of different factors (e.g., a certain time before/after the direction change, a certain distance before/after the direction change, etc.).

The touch device 102 is configured to activate the assistant window 130 (i.e., the assistant window will pop-up) when the touch device detects a switchback movement of touch cursor 110 that is coupled with a localized termination of cursor movement. That is, the triggering movement (i.e., the movement of cursor 110 that causes assistant window 130 to be activated) is comprised of a detected switchback movement along with movement of the touch cursor 110 entirely within a predetermined localized screen region/area during a predetermined period of time (T). In other words, localized termination of cursor movement refers to movement in which the touch cursor 110 does not pass out of the predetermined screen region within the predetermined time period. The localized region may be a region of touch screen 100 that is, for example, a specific number of pixels within two dimensions (e.g., five pixels by five pixels). As such, in one illustrative example of FIG. 3, the assistant window 130 is activated when the cursor 110 does not pass out of a 5×5 pixel region during a period of approximately 0.5 seconds and the path 150 constructed by the locations 142, 144, and 146 has an angle 148 that is less than or equal 45 degrees.

Certain embodiments of the present invention may use further attributes of the cursor movement to determine whether or not to activate the assistant window 130. In one specific such embodiment, the touch device 102 is configured to track the speed of the touch cursor 110 along path 150 and use the detected speed as part of the triggering movement. For example, the assistant window 130 may only be activated when the speed of the touch cursor 110 while undergoing the switchback movement (e.g., the speed of the cursor through points 142, 144, and 146) is greater than a predetermined threshold. Other cursor movement attributes may be used in further embodiments to determine whether a triggering movement has been detected.

As noted above with reference to FIGS. 2A and 2B, when the assistant window 130 is activated, the assistant window displays a magnified view of an area of the touch screen that includes part of the touch cursor 110, particularly the tip 116. In one embodiment, the touch device 102 may magnify an area within a distance (d) from the tip 116, including a distance (d) in the direction of touch cursor 110 (i.e., a distance into the touch cursor 110 starting from tip 116).

In accordance with embodiments of the present invention, the angle that indicates switchback movement, the time period, the size of the localized region, the magnification distance (d), etc. may be set by a developer. In certain embodiments, one or more of these values may be adjusted by a user.

As noted above, the assistant window 130 is displayed to facilitate the user's selection (click) of a target feature. Once the target feature is selected, the assistant window 130 may be closed/deactivated so that normal operation of the touch cursor 110 may continue without the assistant window until another triggering movement is detected. Embodiments of the present invention include several techniques for closing the assistant window 130. These techniques may be used together or separately in accordance with various embodiments of the present invention.

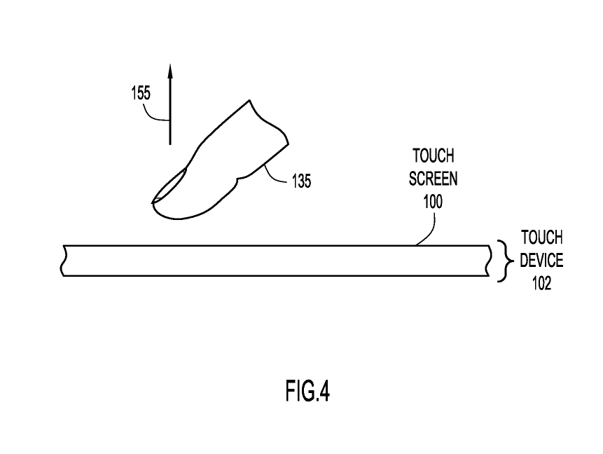

In accordance with one embodiment, the assistant window 130 is closed by physically releasing the touch cursor 110. More specifically, as shown in FIG. 4, the user may release touch sensitive area 112 (FIG. 3) by removing his/her finger 135 from touch screen 100 (e.g., in the direction of arrow 155). When the user releases the touch sensitive area 112, the assistant window 130 may automatically close. A user's release of the touch sensitive area 112 that will cause the assistant window 130 to close may be a release that occurs for a predetermined period of time. In other words, only a release that is longer than a certain period of time may cause closure of the assistant window 130 so as to avoid inadvertent closure when the user attempts to click or double-click on the target feature.

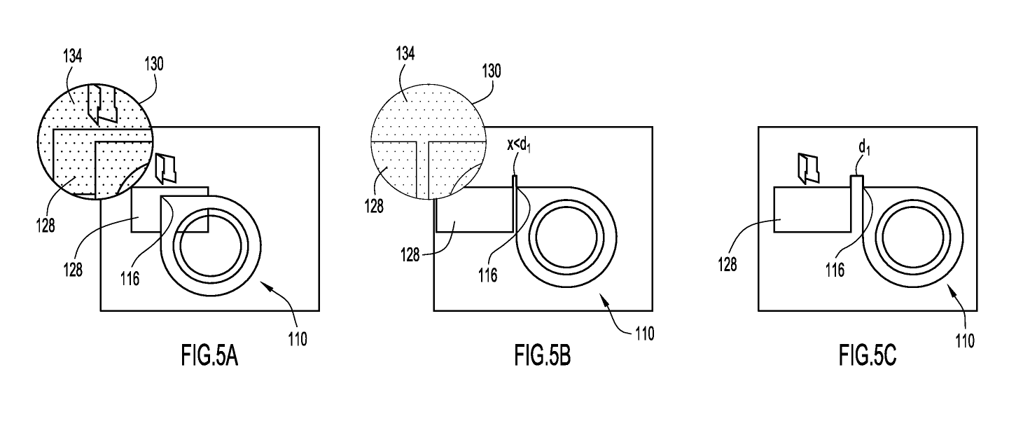

In accordance with another embodiment, the assistant window 130 is closed as a result of specific movement of the touch cursor 110, such as movement away from the target feature. More specifically, FIGS. 5A, 5B, and 5C are schematic diagrams illustrating the closure of assistant window 130 when the target feature is a text field, such as text field 128. Initially, as shown in FIG. 5A, the tip 116 is located within the text field 128. As shown in FIG. 5B, the user drags touch cursor 110 such that the tip 116 leaves the text field 128 and is a distance X away from the text field. As shown in FIG. 5C, once the user drags the touch cursor 110 such that the tip 116 is a distance d1 from the text field 128, the assistant window 130 closes. In certain embodiments, the distance d1 is approximately six (6) pixels. In summary, FIGS. 5A-5C illustrate an embodiment in which the touch device 102 is configured to close the assistant window 130 when the touch cursor 110 is moved a predetermined distance from a portion of a target feature.

In accordance with the examples of FIGS. 5A-5C, the assistant window 130 fades as the tip 116 is moved away from the text field 128. In other words, the assistant window 130, including the magnified text field, tip 116, and semi-transparent mask, become lighter as the distance between the tip 116 and the text field 128 increases to distance d1. Once distance d1 is reached, the assistant window 130 disappears from the touch screen 100. For example, when the assistant window 130 leaves the text field 128 by over six (6) pixels, the assistant window 130 will start to fade out over the first five (5) pixels and it will completely disappear upon reaching the sixth pixel.

In certain embodiments in which the assistant window 130 fades as the tip 116 is moved away from the text field 128, the user may wish to return to the text field 128 before the tip 116 reaches the distance d1. In such embodiments, the touch device 102 may be configured to re-darken the assistant window 130 as the user moves the tip 116 of cursor 110 back towards the text field 128 such that the assistant window 130 reaches its original state when the tip 116 re-enters the text field.

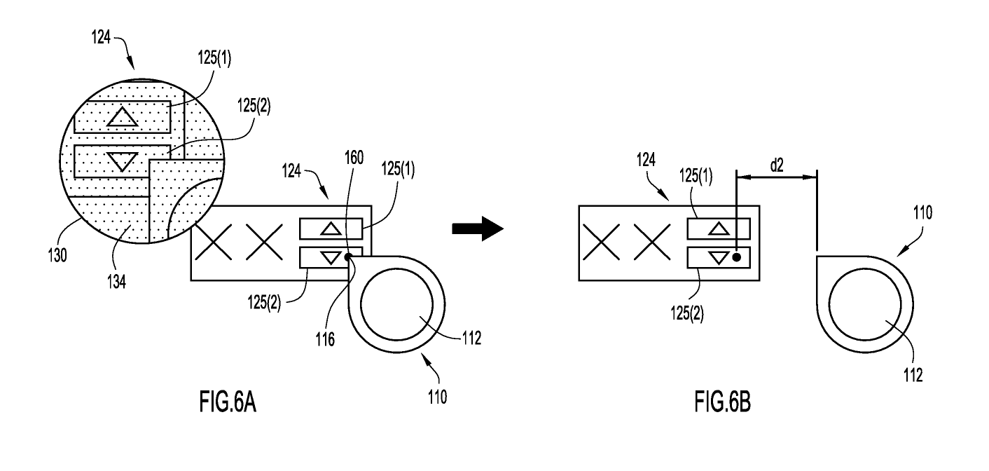

FIGS. 6A and 6B illustrate another example in which the assistant window 130 is closed as a result of specific movement of the cursor 110, particularly movement away from a predefined anchor point. More specifically, FIGS. 6A and 6B are schematic diagrams illustrating the closure of assistant window 130 when the target feature is a composite button, such as composite button 124 comprising scroll arrows 125(1) and 125(2). Initially, as shown in FIG. 6A, the tip 116 is located over the scroll arrow 125(2). The touch device 102 is configured to set an anchor point 160 at the scroll arrow 125(2).

The anchor point 160, which is not visible to the user, operates as a reference point for closure of assistant window 130. For example, as shown in FIG. 6B, the user drags touch cursor 110 such that the tip 116 leaves the scroll arrow 125(2) and, eventually, is a distance d2 away from the anchor point 160. Once the user drags cursor 110 such that the tip 116 is the distance d2 from the anchor point 160, the assistant window 130 closes. In certain embodiments, the distance d2 is approximately six (6) pixels. In summary, FIGS. 6A and 6B illustrate an embodiment in which the touch device 102 is configured to close the assistant window 130 when the cursor 110 is moved a predetermined distance from a predetermined reference point.

In accordance with the examples of FIGS. 6A and 6B, the assistant window 130 fades as the tip 116 is moved away from the anchor point 160. In other words, the assistant window 130, including the magnified text field, tip 116, and semi-transparent mask, become lighter as the distance between the tip 116 and the anchor point 160 increases, until the distance d2 is reached at which point the assistant window 130 disappears from the touch screen 100. For example, when the assistant window 130 leave the anchor point over six (6) pixels, the assistant window will start to fade out over the first five (5) pixels and it will completely disappear upon reaching the sixth pixel.

In certain embodiments in which the assistant window 130 fades as the tip 116 is moved away from the anchor point 160, the user may wish to return to the scroll arrow 125(2) or another part of the composite button 124 before the tip 116 reaches the distance d2. In such embodiments, the touch device 102 may be configured to re-darken the assistant window 130 as the user moves the tip 116 of touch cursor 110 back towards the anchor point 160 such that the assistant window 130 reaches its original state when the tip 116 re-enters the text field.

The location of anchor point shown in FIGS. 6A and 6B is illustrative and the anchor point could be placed at the other locations based on a number of factors. In one embodiment, the location of the anchor point 160 is selected as the point at which the user clicks the touch screen 100 using the touch cursor 110.

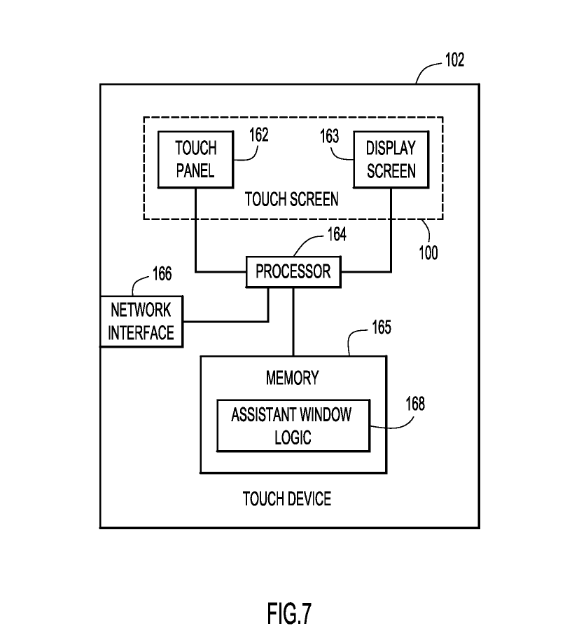

Reference is now made to FIG. 7 that shows a block diagram of the touch device 102. The touch device 102 comprises, among other features, a touch screen 100 that includes a touch sensor (panel) 162 that is positioned in front of, or integrated with, a display screen 163. The touch device 102 also comprises a processor 164, a memory 165, and a network interface 166. The touch panel 162, display screen 163, memory 165, and network interface 166 are coupled to the processor 164.

The display screen 163 is configured to display a touch activated cursor and assistant window (as described above) and the touch panel 162 is configured to receive one or more touch inputs from the user of the touch device 102 that control the cursor. The touch panel 162 and the display screen 163 may be implemented as an integrated unit.

The processor 164 is a microprocessor or microcontroller that is configured to execute program logic instructions (i.e., software) for carrying out various operations and tasks described herein. For example, the processor 164 is configured to execute assistant window logic 168 that is stored in the memory 165 to perform the assistant window operations described herein. More specifically, the processor 164 may execute the assistant window logic 168 to, for example, detect a triggering movement, activate and display the assistant window, close the assistant window, etc. The memory 165 may comprise read only memory (ROM), random access memory (RAM), magnetic disk storage media devices, optical storage media devices, flash memory devices, electrical, optical or other physical/tangible memory storage devices.

It is to be appreciated that the assistant window logic 168 may take any of a variety of forms, so as to be encoded in one or more tangible computer readable memory media or storage device for execution, such as fixed logic or programmable logic (e.g., software/computer instructions executed by a processor). The processor 164 may be an application specific integrated circuit (ASIC) that comprises fixed digital logic, or a combination thereof. For example, the processor 164 may be embodied by digital logic gates in a fixed or programmable digital logic integrated circuit, in which digital logic gates are configured to perform the operations of the assistant window logic 164.

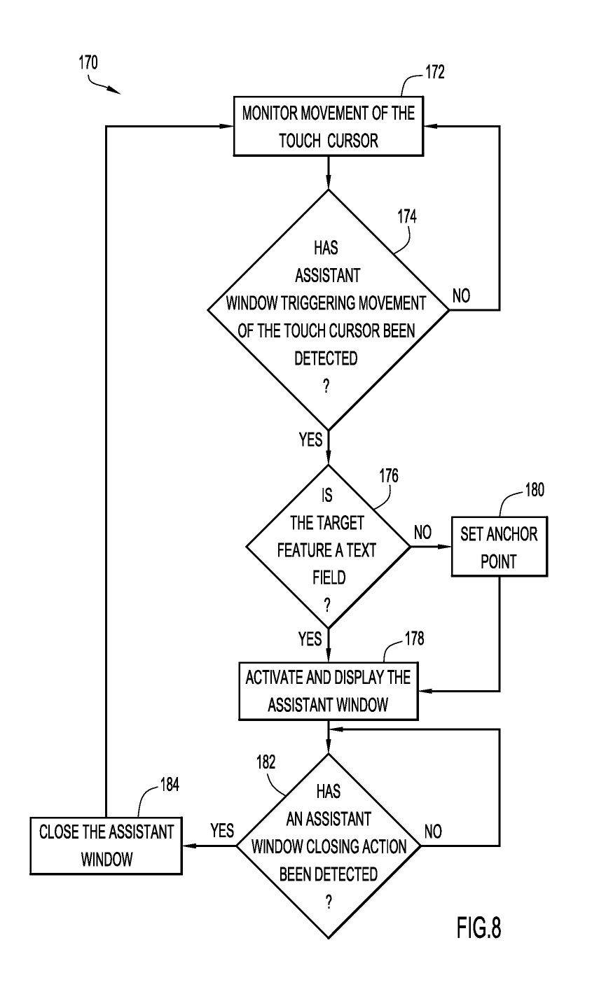

FIG. 8 is a detailed flowchart of a method 170 in accordance with embodiments of the present invention. For ease of illustration, the method 170 is described with reference to touch device 102 of FIGS. 1-7.

Method 170 begins at 172 where the touch device 102 monitors the movement of the touch cursor 110 at the touch screen 100. At 174, a determination is made as to whether or not an assistant window triggering movement of the touch cursor 110 has been detected. If an assistant window triggering movement has not been detected, the method 170 returns to 172. However, if an assistant window triggering movement has been detected, the method proceeds to 176.

At 176, a determination is made as to whether or not a target feature in proximity to the touch cursor 110, at the time of detection of the assistant window triggering movement, is a text field. If the target feature is a text field, the method 170 proceeds to 178. However, if the target feature is not a text field, the method proceeds to 180 where the touch device 102 sets an anchor point for the touch cursor 110. After setting the anchor point, the method again proceeds to 178.

At 178, the touch device 102 activates and displays the assistant window 130. As noted above, the assistant window is a pop-up element that magnifies a portion of the touch activated cursor 110 and a display area of the touch screen 100 adjacent to an end (e.g., tip 116) of the touch cursor. Next, at 182, a determination is made as to whether or not an assistant window closing action has been detected. Assistant window closing actions, which are described above with reference to FIGS. 4-6B, may include a release of the touch cursor 110 by the user or specific movement of the cursor away from a reference point of the touch screen 100. The method 170 enters a loop at 182 until an assistant window closing action has been detected.

Once an assistant window closing action has been detected, at 184 the assistant window is closed. The method 170 then returns to 172 for monitoring of the movement of the touch cursor 110.

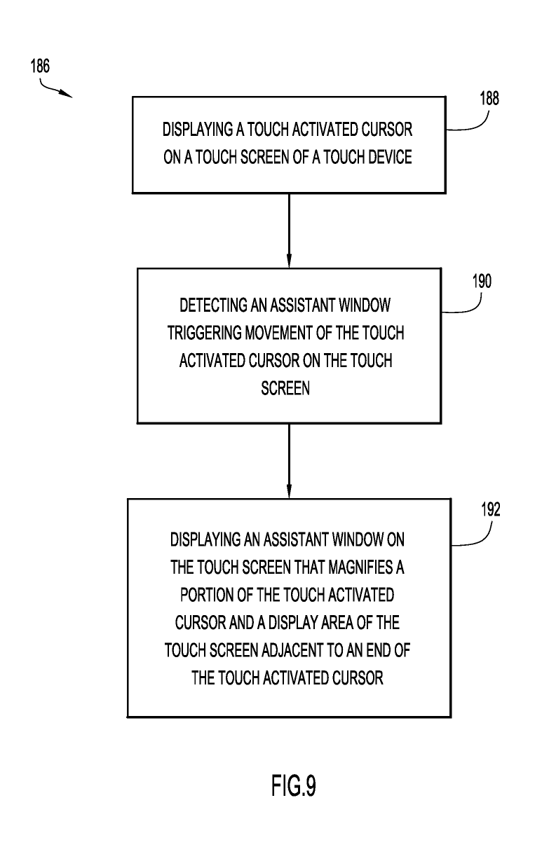

FIG. 9 is a high-level flowchart of a method 186 in accordance with embodiments of the present invention. Method 186 starts at 188 where a touch activated cursor is displayed on a touch screen of a touch device. At 190, the touch device detects an assistant window triggering movement of the touch activated cursor on the touch screen. At 192, the touch device displays an assistant window on the touch screen. The assistant window is a pop-up element that magnifies a portion of the touch activated cursor and a display area of the touch screen adjacent to an end of the touch activated cursor.

Aspects of the present invention offer users an increased ability to select small objects and text fields at a touch screen. Generally, a user will no longer need to carefully aim, but rather can rely on the assistant window to easily click the correct target feature.

The above description is intended by way of example only.

What is claimed is:

1. A method, comprising:
displaying a touch activated cursor on a touch screen of a touch device;
detecting an assistant window triggering movement of the touch activated cursor on the touch screen; and
displaying an assistant window on the touch screen that magnifies a portion of the touch activated cursor and an area of the touch screen adjacent to an end of the touch activated cursor.

2. The method of claim 1, wherein the touch activated cursor comprises:
a touch sensitive area; and
a pointer extending from the touch sensitive area and ending in a tip,
wherein the assistant window displays a magnification of the area within a predetermined distance from the tip.

3. The method of claim 1, wherein detecting an assistant window triggering movement of the touch activated cursor on the touch screen comprises:
detecting a switchback movement of the touch activated cursor; and
determining that at least a portion of the touch activated cursor has remained within a predetermined screen region during a predetermined period of time.

4. The method of claim 3, wherein detecting a switchback movement of the touch activated cursor comprises:
detecting a change of direction of the touch activated cursor that comprises an angle that is less than or equal to approximately forty-five (45) degrees.

5. The method of claim 3, further comprising:
determining that a speed of the touch activated cursor during the switchback movement is greater than a predetermined threshold speed.

6. The method of claim 1, wherein the assistant window includes a semi-transparent mask.

7. The method of claim 1, further comprising:
detecting a touch release of the touch activated cursor; and
closing the assistant window in response to the detected touch release.

8. The method of claim 1, further comprising:
detecting movement of the touch activated cursor away from a predetermined location of the touch screen; and
closing the assistant window when the touch activated cursor is moved a predetermined distance from the predetermined location.

9. The method of claim 8, wherein the predetermined location is a text field.

10. The method of claim 8, further comprising:
setting an invisible anchor point upon initially displaying the assistant window, wherein the predetermined location is the invisible anchor point.

11. The method of claim 8, further comprising:
fading the assistant window as the touch activated cursor is moved away from the predetermined location until the predetermined distance is reached.

12. An apparatus, comprising:
a memory;
a touch screen comprising a touch panel and a display screen; and
a processor configured to:
display a touch activated cursor on a touch screen of a touch device
detect an assistant window triggering movement of the touch activated cursor on the touch screen; and
display an assistant window on the touch screen that magnifies a portion of the touch activated cursor and an area of the touch screen adjacent to an end of the touch activated cursor.

13. The apparatus of claim 12, wherein the touch activated cursor comprises:
a touch sensitive area; and
a pointer extending from the touch sensitive area and ending in a tip,
wherein the assistant window displays a magnification of the area within a predetermined distance from the tip.

14. The apparatus of claim 12, wherein to detect an assistant window triggering movement of the touch activated cursor on the touch screen the processor is configured to:
detect a switchback movement of the touch activated cursor; and
determine that at least a portion of the touch activated cursor has remained within a predetermined screen region during a predetermined period of time.

15. The apparatus of claim 14, wherein to detect a switchback movement of the touch activated cursor, the processor is configured to:
detect a change of direction of the touch activated cursor that comprises an angle that is less than or equal to approximately forty-five (45) degrees.

16. The apparatus of claim 14, wherein the processor is configured to:
determine that a speed of the touch activated cursor during the switchback movement is greater than a predetermined threshold speed.

17. The apparatus of claim 12, wherein the assistant window includes a semi-transparent mask.

18. The apparatus of claim 12, wherein the processor is configured to:
detect movement of the touch activated cursor away from a predetermined location of the touch screen; and
close the assistant window when the touch activated cursor is moved a predetermined distance from the predetermined location.

19. The apparatus of claim 18, wherein the processor is configured to:
fade the assistant window as the touch activated cursor is moved away from the predetermined location until the predetermined distance is reached.
